(19) United States
(12) Patent Application Publication
(10) Pub. No.: US 2026/0101862 A1
(43) Pub. Date: Apr. 16, 2026

(54) SYSTEM AND METHOD FOR PRODUCING CHEESE

(71) Applicant: MALT Cheese LLC, Wheaton, IL (US)

(72) Inventor: Miguel Angel Leal Toriello, Chicago, IL (US)

(21) Appl. No.: 19/325,806

(22) Filed: Sep. 11, 2025

Related U.S. Application Data
(60) Provisional application No. 63/693,847, filed on Sep. 12, 2024.

(51) Int. Cl. A01J 25/00; A01J 25/11; A01J 27/04; A23C 19/024; A23C 19/064; A23C 19/068

(52) U.S. Cl. CPC A01J 25/002; A01J 25/008; A01J 25/114; A01J 27/04; A23C 19/024; A23C 19/064; A23C 19/0684

(57) ABSTRACT

A novel and advantageous system and method for producing cheese is disclosed. Particularly, the present disclosure relates to a novel and advantageous system and method for producing cheese wherein coagulation occurs while milk is moving. The system may include a tube or pipe and a grinder. Milk mixed with coagulant is pushed through the coagulation tube. The milk coagulates during transfer through the coagulation tube. Cheese curd is expelled from the coagulation tube and directed for further processing.

### CROSS-REFERENCE TO RELATED APPLICATIONS

The present disclosure claims priority to and the benefit of U.S. Provisional Application No. 63/693,847, entitled SYSTEM AND METHOD FOR PRODUCING CHEESE, and filed 12 Sep. 2024, the entire contents of which are hereby incorporated by reference herein in its entirety.

### FIELD OF THE INVENTION

The present disclosure relates to a novel and advantageous system and method for producing cheese. Particularly, the present disclosure relates to a novel and advantageous system and method for producing cheese wherein coagulation occurs while a mixture of milk and coagulant is moving. More particularly, the present disclosure relates to a novel and advantageous system and method for producing cheese wherein coagulation occurs while milk and coagulant are moving through a coagulation tube.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In cheese production, milk is received and separated into skim milk and cream, using rennet. This is done by putting the milk in a vat, adding rennet with a pump, and letting the solution sit for a period of time (for example, 15-20 minutes) without movement. This results in some cooking of the formed product.

The skim milk is deposited in silos (or other repositories) and powders are added to increase the solid content, for example up to 60%. After the solid content is increased, flavors are added and the product is put through a pasteurizer. After pasteurization, the product can be sent through a homogenizers (with or without pressure). Coagulation of the pasteurized milk can be achieved by acidifying (to a pH between about 5.0 and 6.0), with coagulating enzymes (such as rennet) added to enhance coagulation.

After coagulation, the resulting cheese curd, together with a variety of possible additives, is cooked and cooled to produce cheese. For producing cotija cheese, for example, the cheese curd is milled into small pieces, mixed with salt, and pressed to remove moisture. Different types of cheese are made by varying this process as is known in the art, for example, Oaxaca and mozzarella cheeses may be made by working and stretching the heated cheese prior to cooling.

The cream is inoculated with lipase enzyme and cultured to add flavor.

The initial step of sitting the milk with rennet in a vat for periods of, for example, 15-20 minutes is time consuming when a large quantity of cheese is being produced.

There is a need in the art for a system and method for producing cheese that does not require a lengthy setting time for coagulation, and that can be readily adapted for producing a number of different cheeses.

### SUMMARY

The present disclosure relates to a novel and advantageous system and method for producing cheese. Particularly, the present disclosure relates to a novel and advantageous system and method for producing cheese wherein coagulation occurs while milk is moving. More particularly, the present disclosure relates to a novel and advantageous system and method for producing cheese wherein coagulation occurs while milk is moving through a long coagulation tube. The system and method may be useful for producing soft cheeses such as, but not limited to, mascarpone, mozzarella, queso fresco, Oaxaca, and ricotta. The systems and method may further be modified to produce semi-soft, hard or extra hard cheese including cheddar, cheddar-like cheese, gouda, gouda-like cheese, parmesan, parmesan-like cheese.

The systems and methods of the present disclosure result in higher throughput, improved aesthetics, and higher yield. The high rates at which the ingredients flow through the systems allow for stabilization and fermentation without the use of common preservatives that normally detract from cheese flavor. Moreover, the systems and methods of the present disclosure are highly adaptable and can be drafted into many cheese manufacturing operations, even those with traditionally labor intensive steps (e.g., pulling Oaxaca cheese).

In one aspect, the present disclosure provide a system for forming cheese, the system comprising; a milk tank for holding milk; a rennet pump for adding rennet to the milk to form a milk and rennet mixture; a tube coagulator, wherein the milk and rennet mixture coagulates while traveling through the tube coagulator and curd exits the tube coagulator; and a grinder for grinding the curd.

In another aspect, the present disclosure provides a method for forming soft cheese, the method comprising: adding rennet to a milk precursor to form a milk and rennet mixture; forcing the milk and rennet mixture through an elongated tube coagulator, wherein the milk and rennet mixture forms a curd as it travels through the tube coagulator; cooking the curd; at least partially drying the cooked curd; salting the dried curd; and grinding the salted curd in the presence of carbon dioxide.

In yet another aspect, the present disclosure provides a method for forming Oaxaca cheese, the method comprising: adding rennet to a milk precursor to form a milk and rennet mixture; forcing the milk and rennet mixture through an elongated tube coagulator, wherein the milk and rennet mixture forms a curd as it travels through the tube coagulator; cooking the curd; stretching and heating the cooked curd to form opened structures; and cooling the opened structures in a bath.

In yet another aspect, the present disclosure provides a method for forming Oaxaca cheese, the method comprising: adding rennet to a milk precursor to form a milk and rennet mixture; forcing the milk and rennet mixture through an elongated tube coagulator, wherein the milk and rennet mixture forms a curd as it travels through the tube coagulator; cooking the curd; stretching and heating the cooked curd to form opened structures; cooling the opened structures in a bath; shredding the cooled curd; applying cellulose to the curd; and grinding the curd.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1A illustrates a first portion of a system for producing cheese, in accordance with one embodiment.

FIG. 1B illustrate a second portion of a system for producing cheese, in accordance with one embodiment.

FIG. 2 illustrates milk silos, a solids funnel, a skimmer, and cream tanks, in accordance with one embodiment.

FIG. 3A illustrates milk silos and a solids funnel 3, in accordance with one embodiment.

FIG. 3B is a picture of a milk silo and solids funnel, in accordance with one embodiment.

FIG. 3C illustrates a skimmer and cream tank, in accordance with one embodiment.

FIG. 4 illustrates a pasteurizer, a homogenizer, milk tanks, a rennet pump, a rennet stirring tube, a coagulation tube, and a cheese conveyor, in accordance with one embodiment.

FIG. 5A illustrates a pasteurizer and a homogenizer, in accordance with one embodiment.

FIG. 5B illustrates milk tanks, a rennet pump, and a rennet stirring tube, in accordance with one embodiment.

FIG. 6 illustrates a carbon dioxide applicator, in accordance with one embodiment.

FIG. 7A1 illustrates a coagulation tube, in accordance with one embodiment.

FIG. 7A2 illustrates a coagulation tube, in accordance with one embodiment.

FIG. 7B illustrates a coagulation tube angled at 45 degrees up, in accordance with one embodiment.

FIG. 7C illustrates a coagulation tube angled at 60 degrees up, in accordance with one embodiment.

FIG. 7D is a picture of a coagulation tube with curd exiting the distal end thereof.

FIG. 7E illustrates a coagulation tube comprising flexible tubing arranged in a spiral with no junctions, according to embodiments of the present disclosure.

FIG. 8 illustrates a dewatering belt, in accordance with embodiments of the present disclosure.

FIG. 9 illustrates a salt mill, an elevator, and a grinder, in accordance with one embodiment.

FIG. 10A illustrates an elevator, a grinder, a filling pump, and a packaging station, in accordance with one embodiment.

FIG. 10B is a photograph of cheese emerging from the filling pump of FIG. 10A.

FIG. 11 illustrates aspects of a packaging station and molds, in accordance with one embodiment.

FIG. 12 illustrates an alternative embodiment of a portion of the system showing a coagulation tube, dewatering belt, salt mill, elevator, grinder with carbon dioxide (CO₂) application, and packaging station.

FIG. 13 illustrates an alternative embodiment where cheese is delivered from a grinder to a storage container for subsequent processing or packaging.

FIG. 14A illustrates a first portion of a system for producing cheese, in accordance with another embodiment.

FIG. 14B illustrates a second portion of a system for producing cheese, in accordance with the embodiment of FIG. 14A.

FIG. 15A illustrates a first portion of a system for producing cheese, in accordance with another embodiment.

FIG. 15B illustrate a second portion of a system for producing cheese, in accordance with the embodiment of FIG. 15A.

FIG. 16 illustrates of a portion of the system showing a cold bath, shredder, cellulose applicator, grinder, and packaging station.

FIG. 17 is a picture of curd emerging from a coagulation tube.

FIG. 18 is a picture of at least partially cooked curd.

### DETAILED DESCRIPTION

Using the systems and methods to produce cheese described herein, milk is in motion during coagulation. Precursor milk is received and a coagulant, such as rennet, is added to coagulate the milk. The milk and rennet mixture is pushed through a coagulation tube. As it coagulates, curd travels through the coagulation tube and is pushed from the tube. Upon exiting the tube, the curd may be cooked, dried, and/or sent to a grinder or other mechanism for crumbling the curd. Carbon dioxide may be injected during the process. In some embodiments, carbon dioxide is injected at the grinder or before packaging. In other embodiments, carbon dioxide is injected into the coagulation tube.

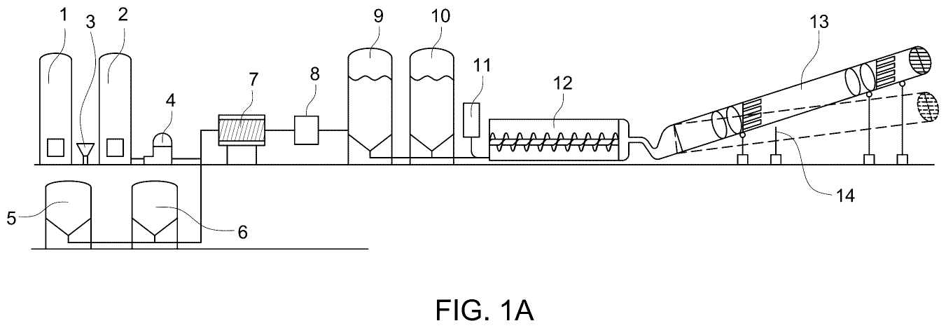

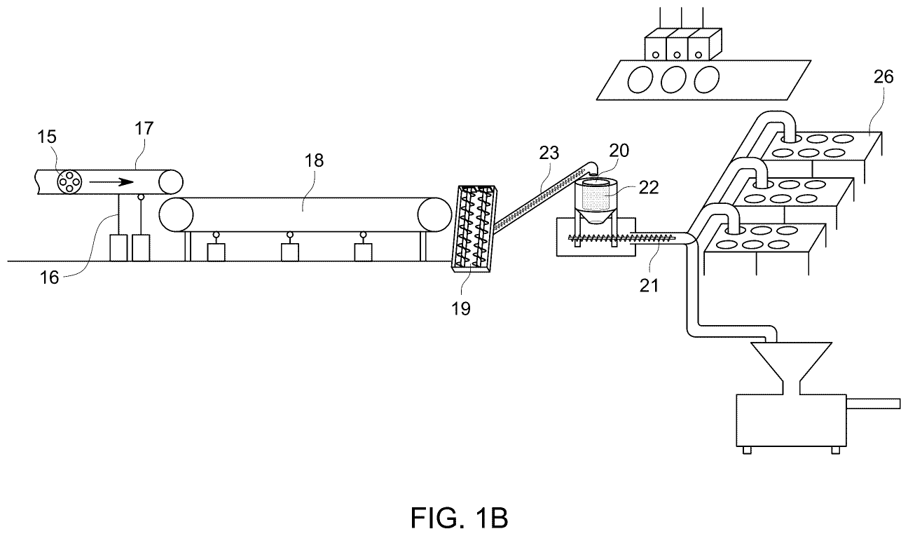

FIGS. 1A and 1B illustrate a system for producing cheese in accordance with one embodiment. An overview of the various components is given with further detail given in description of later figures. In the embodiment shown, the system includes one or more silos 1, 2 for holding milk and a solids funnel 3 for powder or solids addition. Milk moves from the silos 1, 2 to a skimmer 4, from which cream is routed to one or more cream tanks 5, 6 for heating. Alternatively, the cream may be routed through one or more insulated tubes for heating and subsequent processing. The heated cream is routed to a pasteurizer 7 and then to a homogenizer 8. From the homogenizer, the pasteurized milk is sent to one or more tanks 9, 10 where calcium and cultures are added. Pumps may be provided associated with tanks 5, 6 for transporting milk and/or cream through the system.

A coagulant, such as rennet, is added to the loaded milk at pump 11, before the milk is routed to a rennet stirring tube 12. After the milk and rennet are mixed in the rennet stirring tube 12, this pre-curd mixture is pushed through a coagulation tube 13 through which cheese curd is formed. In some embodiments, the coagulation tube is disposed such that the proximal end, or entry portion, of the coagulation tube is at a lower position than the distal end, or output portion such that the curd rises at an incline in the coagulation tube as the pre-curd mixture coagulates. Curd is removed from the distal end of the coagulation tube 13.

The coagulation tube 13 may rest on a pivot point 14 such that it can be raised and lowered to assist with curd entry and removal. The coagulation tube 13 may be lined with Teflon 17 on its interior to minimize any frictional counterforce or other effect on flow of the curd. In presently preferred circumstances, the coagulation tube is insulated to ensure consistent temperature in the pre-curd mixture as it flows through the length of the tube. The temperature of the curd may be changed during the curd preparation, for example via a control of the environmental temperature of the coagulation tube. In some embodiments, a carbon dioxide (CO₂) application point 15 may be provided along the coagulation tube 13. Alternatively, carbon dioxide may not be applied through the coagulation tube 13.

The curd may be transferred from the coagulation tube 12 to a dewatering belt 18 that functions drain the whey and to get the pH of the curd to approximately 5. Salt may be applied at salt mill 19. Salt may be homogenously sprinkled onto the curd surface as dry salt, following coagulation. The curd is sent to a grinder 22, for example via elevator 23, where it is crumbled. Carbon dioxide may be added to the grinder 22 at the CO₂ application point 20. A pump 21 may be used to push desired volumes of crumbled cheese to packaging stations 26.

Detail will now be given to various aspects of the system, as well as methods for forming cheese using the systems of the present disclosure.

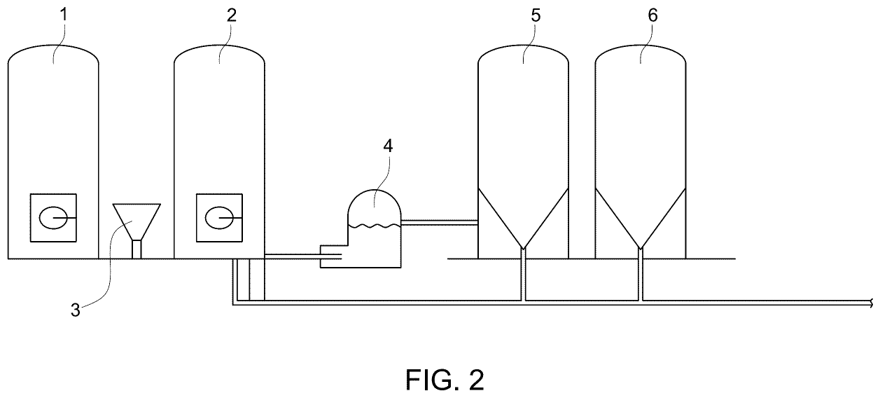

FIG. 2 illustrates milk silos 1, 2, a solids funnel 3, skimmer 4, and cream tanks 5, 6, in accordance with one embodiment. Solids are applied to the milk in the milk silos 1, 2 using the solids funnel 3. These solids may include powders, milk protein concentrate, caseinate, whole milk powder, non-fat dry milk, potato starch, other starches, sodium, and the like. Solids may be added to achieve approximately 20% to 40% solids in the milk. Cream is held in cream tanks 5, 6 where the cream is cultivated to the desired temperature and color. Lipases may be added to the cream to impart flavor. The starting milk may be milk obtained from an animal, such as a cow, sheep, goat, camel, mare or any other animal that produces milk suitable for human consumption (including after sterilization or other processing). The starting milk may be, for instance, whole milk, cream, low-fat or skim milk, low-lactose or lactose-free milk, ultrafiltered milk, diafiltered milk, microfiltered milk, or milk reconstituted from milk powder, organic milk or a combination of these. In presently preferred circumstances, the starting milk is whole milk from a cow.

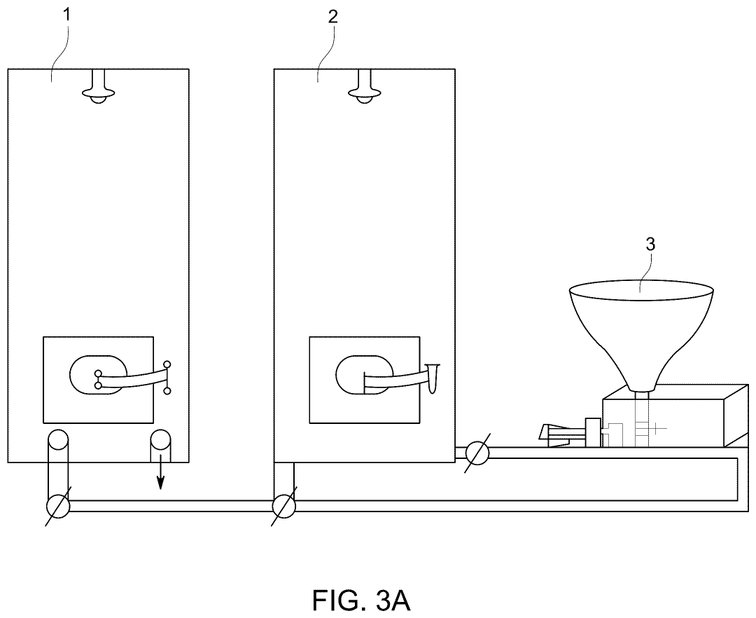

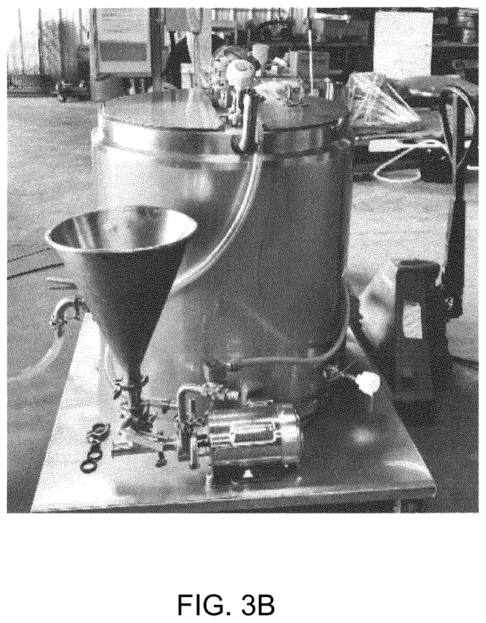

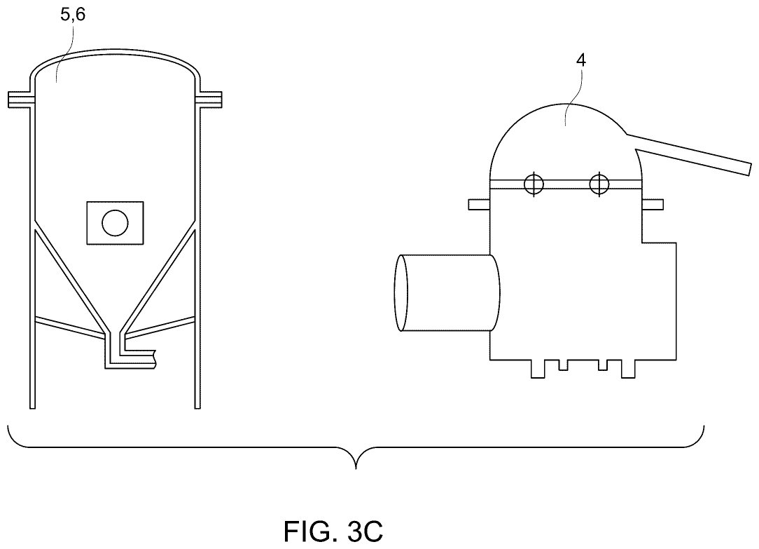

FIG. 3A illustrates milk silos 1, 2 and solids funnel 3 (also referred to as a mixing cone), in accordance with one embodiment. FIG. 3B is a picture of a milk silo and solids funnel, in accordance with one embodiment. The milk silos may be configured to maintain a temperature of the starting milk. For example, the milk silos may be configured to maintain the milk at approximately 2° C. Solids are added using the solids funnel. The solids impart weight to the milk without condensing the milk.

FIG. 3C illustrates skimmer 4 and cream tanks 5, 6, in accordance with one embodiment. The skimmer may be kept at a cool temperature such as, for example 2° C. In some embodiments, the skimmer may have a capacity of 2 volumetric tons of milk. The cream tank 5 is used to impart flavor to the cream. The cream tank (or tubing) 5, 6 may have a jacket for steam and water and a conical ending through which cream is released. The cream may be cultivated with a lipase, such as cow lipase, and/or other cultures as described below. This may be done at 60° C. for approximately 12-15 hours. The cream may be passed through a pasteurizer to reduce taste and readded to the milk. The amount of cream readded will depend on the desired fat content of the resulting cheese.

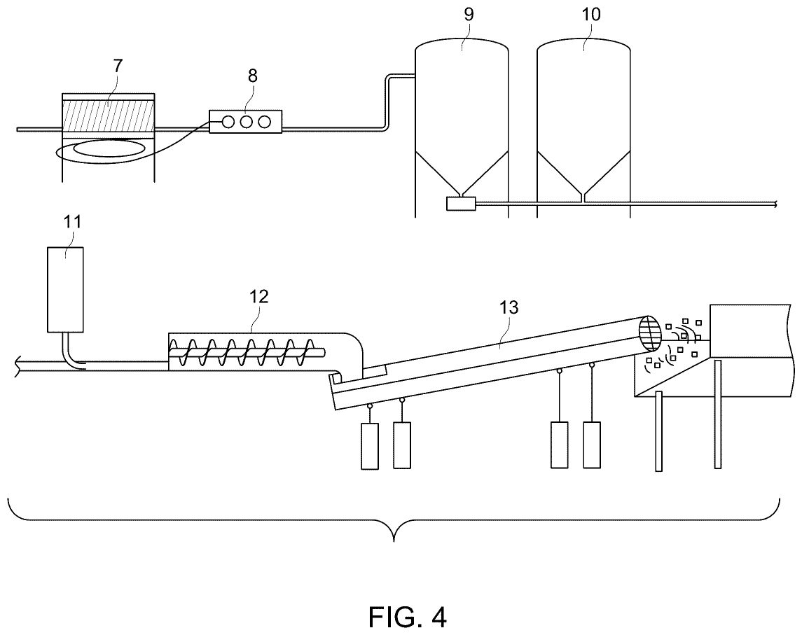

FIG. 4 illustrates pasteurizer 7, homogenizer 8, milk tanks 9, 10, rennet pump 11, rennet stirring tube 12, and coagulation tube 13, in accordance with embodiments of the present disclosure.

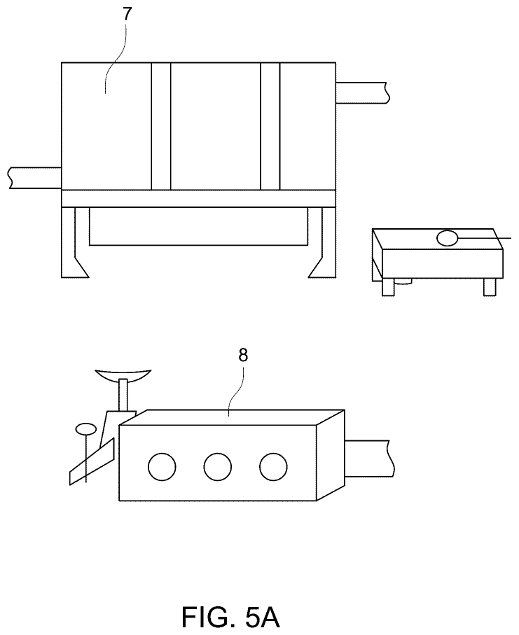

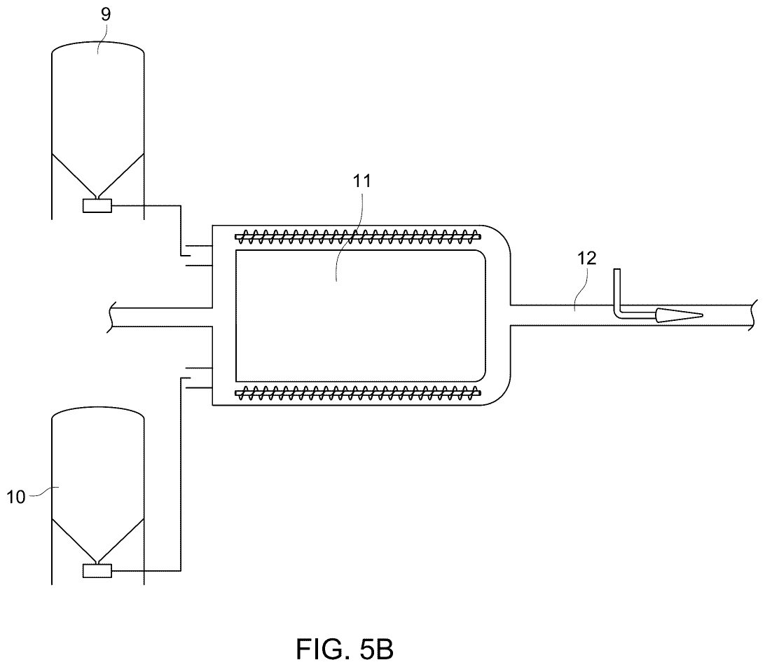

FIG. 5A illustrates the pasteurizer 7 and the homogenizer 8, in accordance with one embodiment. The pasteurizer may be configured for pasteurizing milk with a high percentage, such as 40%, of solids and may process for example, 20 million liters per hour. The pasteurizer may be used to heat the milk to approximately 160° C. -170° C. The milk/cream may be pasteurized and homogenized for a variety of reasons. Generally, heat treatment improves the microbiological quality of the milk The heat treatment can be performed at a temperature ranging from 50° C. to 160° C. Examples of heat treatments to be used are pasteurization, high pasteurization, or heating at a temperature lower than the pasteurization temperature for a sufficiently long time. These processes can stop the lipase that was introduced in the cream tanks. When milk/cream is homogenized with fat, the flavor is enhanced. In some embodiments, vegetable fat may be added at the homogenizer or the cream tank.

FIG. 5B illustrates milk tanks 9, 10, rennet pump 11, and rennet stirring tube 12. Milk tanks 9, 10 are used for cultivation of the creams. Calcium and cultures may be added to the milk tanks 9, 10 and the milk mixed. Calcium chloride may be added at a desired proportion to achieve relatively rapid curdling. For example, the calcium chloride content in the milk is preferably 0.005 to 0.2% by weight, based on the total weight of the milk. The culture to be added can be mesophilic or thermophilic or a mixture thereof and added at 0.0005 to 0.01% by weight. Examples of cultures are: Streptococcus themophilus, Lactobacillus bulgaricus, Lactobacillus helveticus, Lactococcus lactis subspecies cremoris, Lactococcus lactis subspecies lactis. Suitable cultures are available from Danisco A/S, including Choozit® TA 61 and other Choozit® cheese cultures. Cultures may be added to control the pH of the prepared milk mixture (i.e., precursor milk), as well as the subsequent cheese output from the system.

It may be necessary or desirable to perform one or more additional pH adjustment steps. This can take place before or after the stage of pasteurization, and can be done by adding lactic acid, acetic acid, or another acceptable food grade acid. For example, if used, the acid content in the milk mixture is preferably 0.001 to 0.1% by volume, based on the total volume of the milk.

Once any pasteurization and fermentation processes are complete, rennet is pumped into the resultant, pre-cheese milk mixture with the pump assisting in distributing the rennet regularly. Rennet is a chymosin-based curdling enzyme that hydrolyzes the peptide bond of K-casein that stabilizes casein micelles in the presence of milk and calcium. It has the property of gelling milk. Known rennets can be used as appropriate in the manufacture of cheese under the present disclosure, such as bovine-derived rennets, microorganism-derived rennets, and plant-derived rennets.

In one or more embodiments, sufficient rennet is pumped into the milk to achieve 2.4%-4.8% rennet, based on the total volume of pre-cheese milk mixture, with presently preferred circumstances allowing rennet concentration at the lower end of the range. The rennet/milk mixture is mixed in the rennet stirring tube 12. This may be done for example, for one minute. If the amount of rennet added is too small relative to the amount of casein protein in the prepared milk, it takes additional time to fully curd the milk. As the amount of rennet added increases, curdling tends to progress faster. If the amount is too large, however, the flavor of the resulting cheese product will deteriorate. The time period that the curd, for example, requires to reduce its pH to a desired value during the curd maturation is not constant, but can depend on factors such as the composition of the supplied milk, the temperature, and/or the activity of the culture/acid.

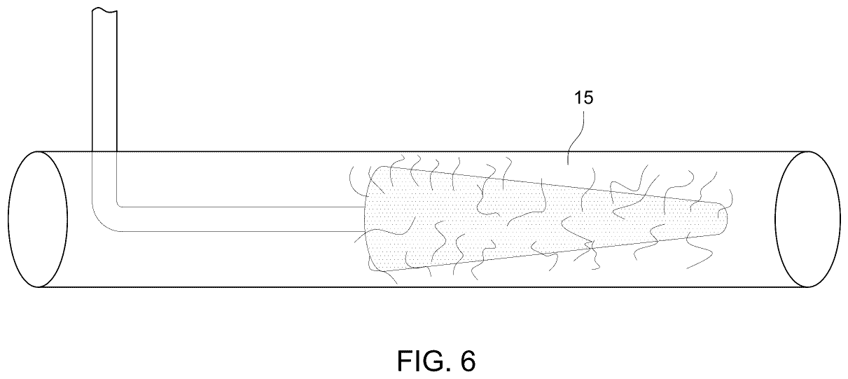

FIG. 6 illustrates a carbon dioxide applicator 15, in accordance with one embodiment. As discussed with respect to FIG. 1, in some embodiments carbon dioxide may be injected before the milk is sent through the coagulation tube 13 or at a point 15 along the coagulation tube 13. Alternatively, carbon dioxide may not be injected at all, not until after curd exits the coagulation tube, or not until the curd is grinded downstream. The carbon dioxide applicator may include a porous stone and may include a tube or other connection to a carbon dioxide source. The carbon dioxide applicator may be used to carbonize the milk for better curdling/yield and to provide a creamier texture.

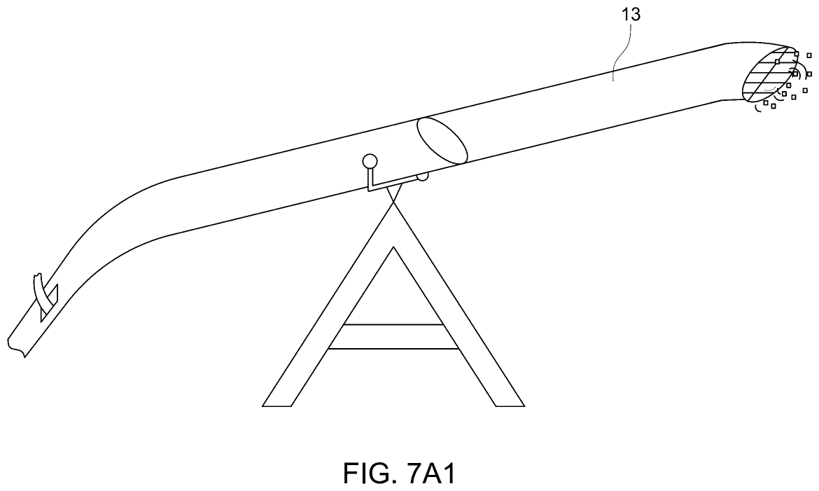

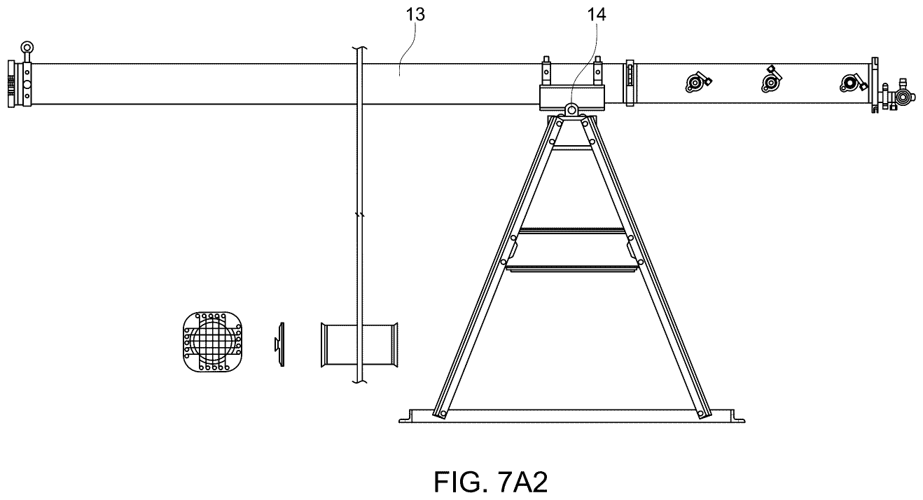

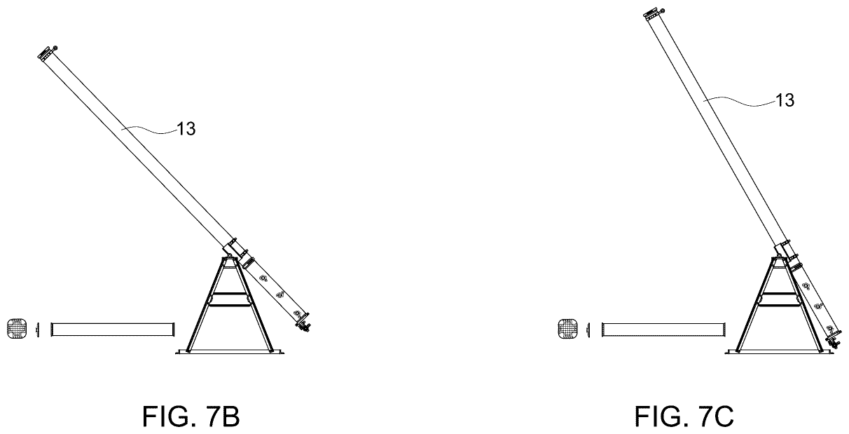

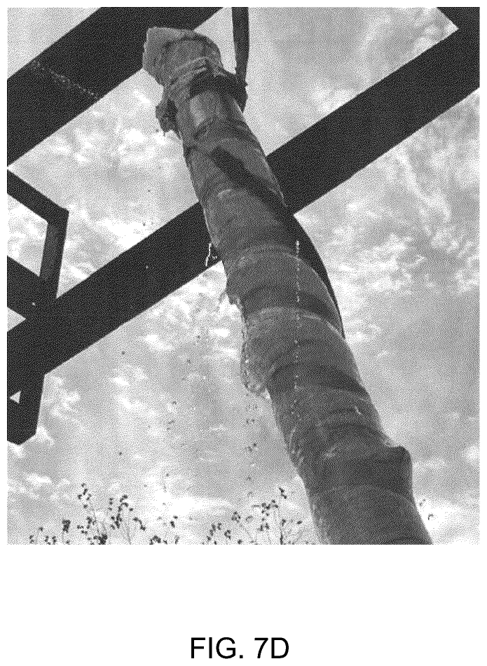

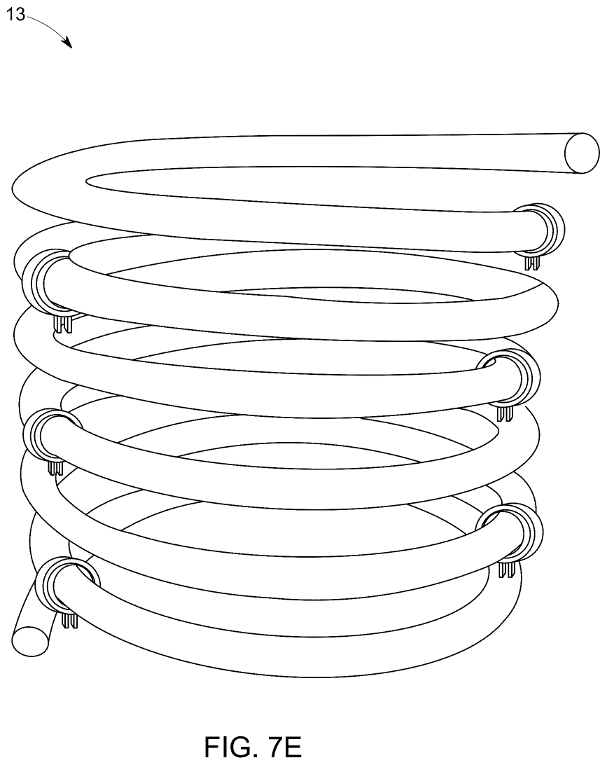

FIGS. 7A through 7E illustrate aspects of a coagulation tube 13 according to multiple embodiments of the present disclosure. Detail of the coagulation tube will be given after a brief description of each of these figures. FIG. 7A1 illustrates a coagulation tube 13, in accordance with one embodiment. FIG. 7A2 illustrates a coagulation tube 13, in accordance with a further embodiment. FIG. 7B illustrates a coagulation tube 13 angled at 45 degrees up, in accordance with one embodiment. FIG. 7C illustrates a coagulation tube 13 angled at 45 degrees up, in accordance with one embodiment. FIG. 7D is a picture of a coagulation tube, with curd exiting the distal end thereof. FIG. 7E illustrates a coiled coagulation tube, according to other embodiments of the present disclosure.

With reference to each of these figures, the pre-curd milk mixture (i.e., precursor milk and rennet) curdles as it travels through the coagulation tube 13. In one embodiment, the coagulation tube is kept at approximately 110° C. The temperature maintained in the coagulation tube may be a temperature at which curdling by rennet occurs to a desired consistency. The texture of the resulting cheese product can be at least partially controlled by the temperature within the coagulation tube. Moreover, the curdling tends to advance faster as the temperature within the tube increases. For example, a fresh cheese product can be obtained when the pH of a precursor milk is 5.2 to 6.4 and the coagulation temperature is 110-116 degrees C. A relatively more basic starting pH and coagulation temperature can be used to create harder cheese products.

The length of the tube dictates, along with the fluid pressure, the amount of time that the milk travels in the tube. Travel through the tube is achieved by coagulation of the milk and can be assisted using a pump. Suitable pumps include mechanical, hydraulic, pneumatic, displacement, and manual pumps, with the PULSAtron Series E chemical metering pump (150 psi, 42 GPD) proving particularly suitable. In presently preferred implementations, the coagulating milk mixture travels through the coagulation tube for a coagulation period of about 5 to 15 minutes, more preferably 5-8 minutes.

In some embodiments, the coagulation tube may be approximately 10-30 feet long with a diameter of approximately 1-20 inches. Assuming a generally uniform length, the volume of the coagulation tube can be varied by changing the diameter of the coagulation tube. In one embodiment, the coagulation tube may be 15 feet long with a diameter of 6 inches. In other embodiments, as contemplated below, the coagulation tube may be 30 feet long with a diameter of about 1 inch. In yet other embodiments, the coagulation tube may be 16 to 30 feet long, with a diameter of 1 inch.

The coagulation tube may be pitched such that the entry end of the coagulation tube is lower than the output end of the coagulation tube. As the milk curdles, it rises within the tube. The pitch of the tube may be from, for example, about 35 degrees to about 75 degrees. In one embodiment, the pitch of the tube is 34 degrees. In another embodiment, the pitch of the tube is 45 degrees. The coagulation tube may be lined with Teflon® PTFE to mitigate any effect of movement on the curd. A water jacket may be provided around the coagulation tube to insulate the coagulation tube and indirectly heat it, for example at 110° C. As discussed above, the temperature of the coagulation tube may vary, depending on the culture used and desired cheese product, but is typically held constant along the length of the tube 13.

A pivot point 14 may be provided to raise and lower the tube, for example to remove curd, with the coagulation tube arranged on a frame assembly. In other embodiments, no pivot may be provided. Further, in some embodiments, different mechanisms for raising or lowering the distal end of the tube may be used. In other embodiments, such as depicted in FIG. 7E, the coagulation tube is coiled and arranged in a spiral. The coagulation tube of FIG. 7E may be coiled about a frame assembly, or may be free-standing. The pitch of spiral may be constant along a height of the coagulation tube assembly, or may vary (e.g., decreasing as the coagulating mixture travels through the tube). In either case, the coiled coagulation tube lacks kinks or junctions that operate to impede travel and/or coagulation.

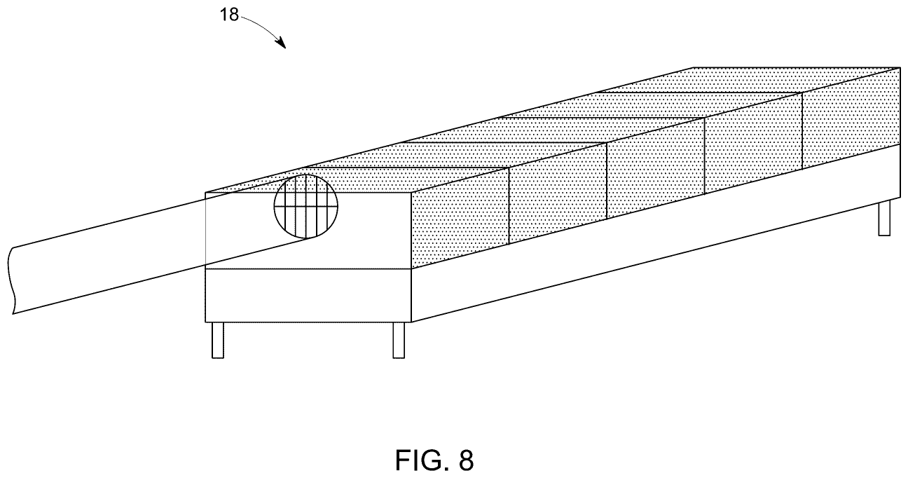

FIG. 8 illustrates a dewatering belt 18, in accordance with one embodiment. After exiting the coagulation tube, the curd and whey move along the dewatering belt 18, which may be motorized. The belt may be made of a plastic, metal or textile, which has holes and tapers in the conveying direction. The dewatering belt 18 functions to remove whey/water and adjust the pH of the curd. In some embodiments, the conveyor belt is sized such that 600 kilos of curd are processed in approximately 5 to 8 hours. The dewatering belt 18 may be subdivided into sections such that salt may be applied at salt mill 19 section by section.

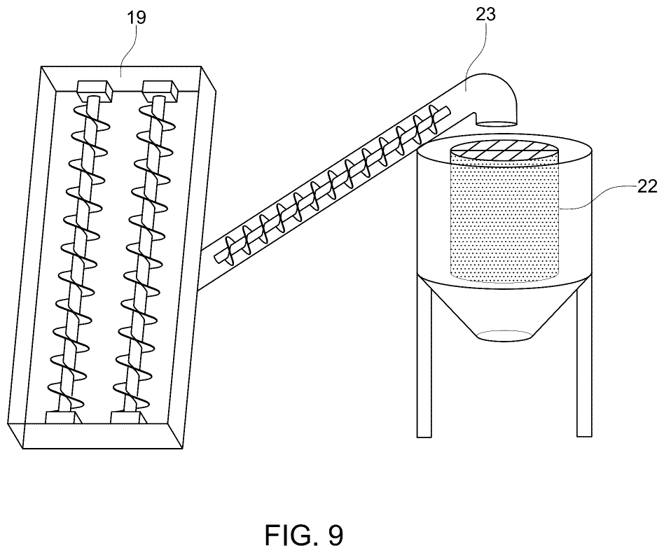

FIG. 9 illustrates a salt mill 19, an elevator 23, and a grinder 22, in accordance with one embodiment. Salt is added to the curd at the salt mill 19 so that the cheese can be ground in a short period of time. The salt may be applied at about 1%-2%, by weight of the curd, such that it does not impart significant taste and cultures can be stopped. The salt mill 19 may include one or more, for example two, threaded shafts for grinding and mixing the cheese with the salt in a short period of time. The salted cheese is transported to the grinder 22, for example using an elevator with conveyor, auger, or other transport mechanism. Carbon dioxide may be added, typically through continuous feed, to the grinder to achieve a light, airy consistency in cheese. Crumbled cheese is removed from the grinder.

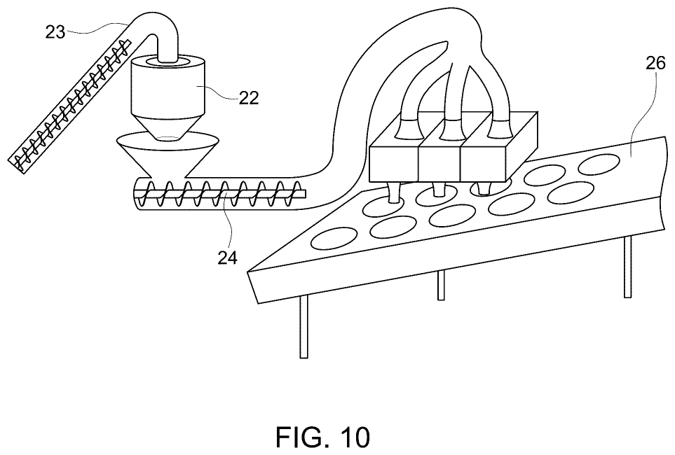

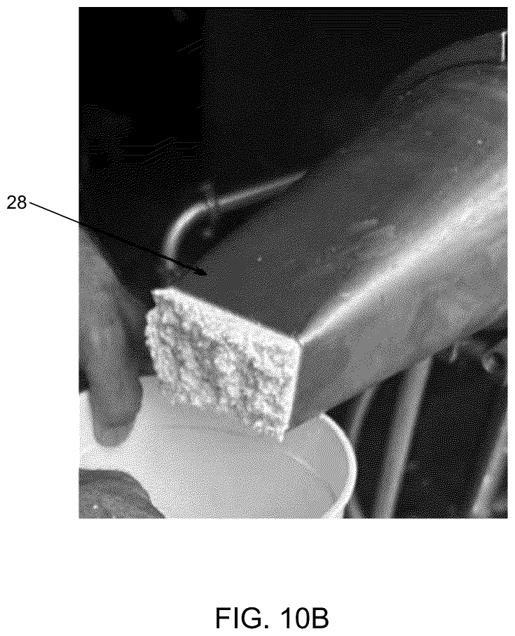

FIG. 10A illustrates the elevator 23, the grinder 22, a filling pump 24, and a packaging station 26, in accordance with one embodiment. Crumbled cheese drops from the grinder 22 to the filling pump. The cheese emerges from the grinder 22 without additional pressure applied, which maintains the benefits imparted by the carbon dioxide. The filling pump 24 pumps and forms the crumbed cheese through filling heads. The filling heads press the crumbled cheese into molds to form relatively uniform or consistent blocks of cheese. Filling heads 28 may have a rectangular, including square, cross-section to form rectangular cheese blocks, as shown in FIG. 10B.

Alternatively the curd particles may be allowed to knit together to form a ‘chicken-breast’ structure, a process that results in a continuous mat of curd, known as “cheddering”. After cheddaring the curd may be milled or ground. Milling/grinding involves cutting the mat of cheddared curd into finger-sized pieces of curd or smaller which can be easily and effectively salted.

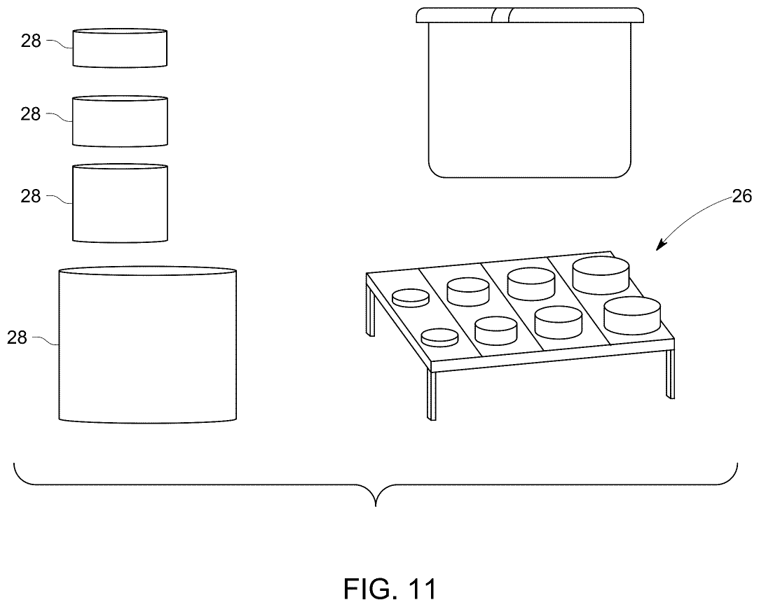

FIG. 11 illustrates aspects of the packaging station 26 and molds 28, in accordance with one embodiment. The packaging machine may be functionally connected to the output line. The molds may be, for example, 10 oz., 12 oz., or 15-16 oz. In some embodiments, the system may be used to produce 9 pound buckets of cheese, 6 pounds wheels of cheese, or any other configurations of cheese.

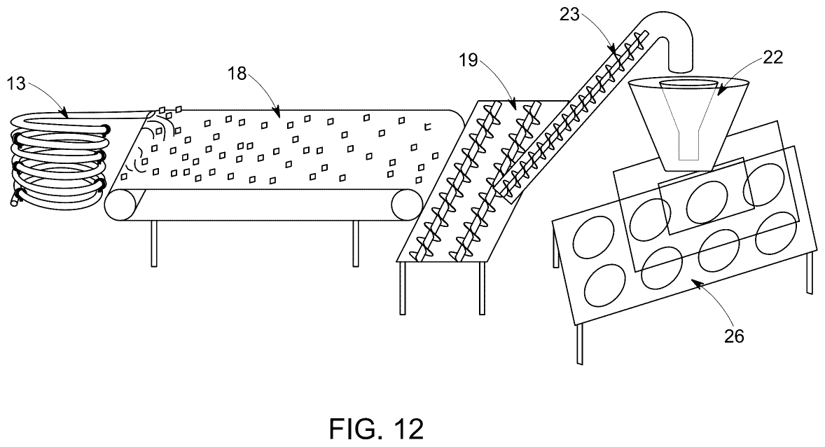

FIG. 12 illustrates an alternative embodiment of a portion of the system showing a coagulation tube 13 (of the type depicted in FIG. 7E), dewatering belt 18, salt mill 19, elevator 23, grinder 22 with optional carbon dioxide (CO₂) application, and packaging station 26.

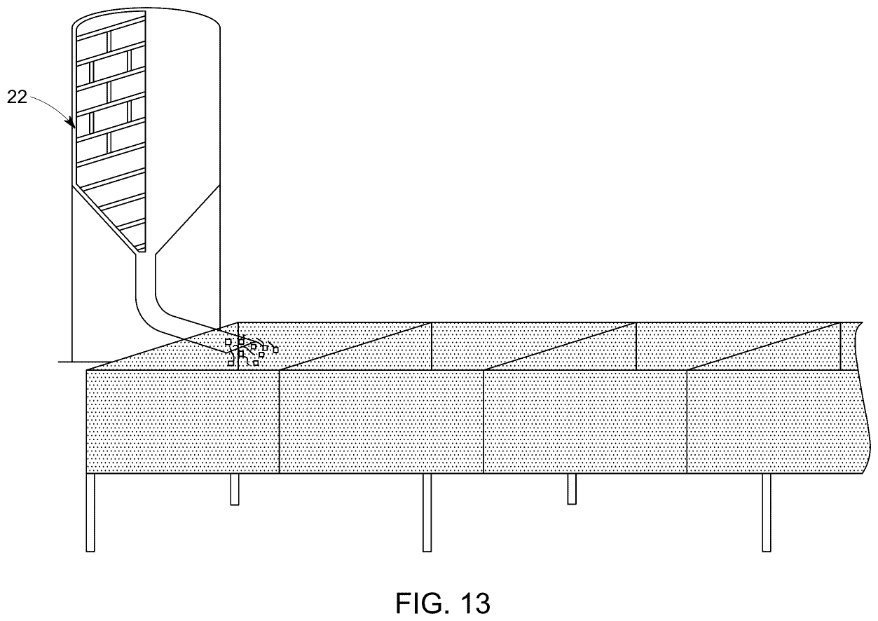

FIG. 13 illustrates an alternative embodiment where ground cheese from the grinder 22 is delivered to containers for storage or further processing.

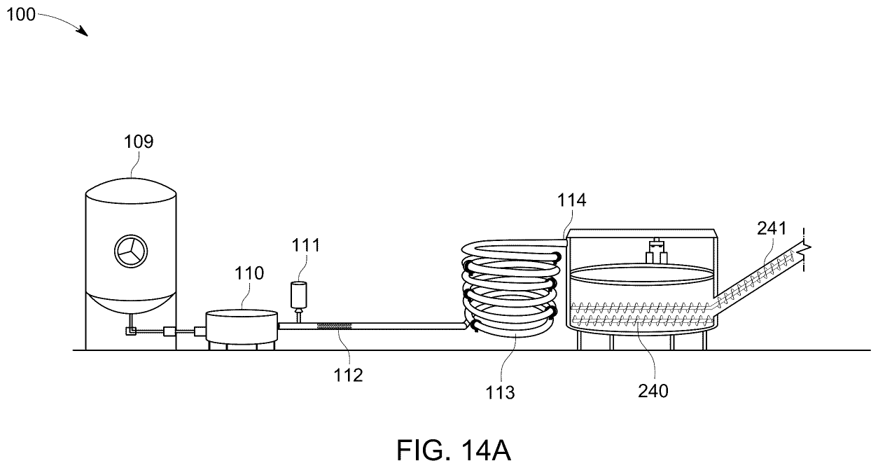

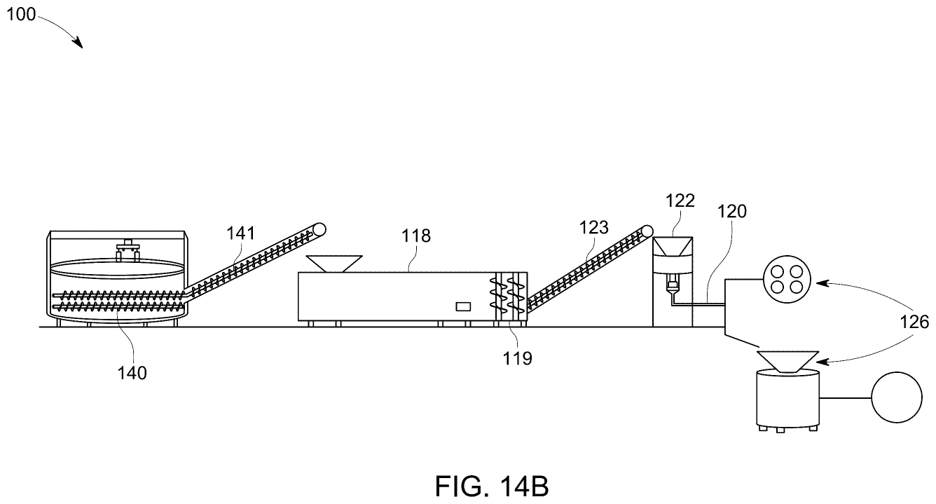

FIGS. 14A and 14B illustrate a system 100 for producing fresh cheese (i.e., queso fresco) in accordance with another embodiment of the present disclosure. The system may incorporate components from systems described above, with like components identified with like reference characters. The system includes a milk tank 109 housing a pre-cheese milk mixture (i.e., precursor milk) with, for example, about 30-60% solids and held at a pH of about 5.5. The pre-cheese milk mixture may include more or less solids content, depending on the desired cheese product and throughput expectations. The system 100 as depicted omits any pre-treatment (i.e., pasteurization, solids addition, etc.) equipment or steps, though the skilled person will recognize that any desired pre-processing may be performed on the milk mixture before storage in the tank 109. The milk mixture is routed through a balance tank 110 to remove any oxygen or other gases captured in the milk mixture.

A coagulant, such as rennet, is added to the milk mixture at pump 111 and routed through a rennet stirring tube 112. After the milk and rennet are mixed in the rennet stirring tube 12 to form a pre-curd mixture, that mixture is pushed through one or more coagulation tubes 113 where curd is formed. Curd continuously emerges from the distal end 114 of the one or more coagulation tubes 113. In presently preferred implementations, the curd remains suspended in a fluid as it flows through the coagulation tube 113, with the viscosity of the pre-curd mixture increasing as it travels through the tube length and coagulates.

The coagulation tube 113 may be inclined, as in the embodiments above, but this is not strictly necessary, as the tube may remain essentially flat and rely on fluid pressure from the tank 109 and/or the pump 111 to drive the coagulating pre-curd mixture through the tube. In certain circumstances, including those with a relative shorter lengths of tube and greater diameter, it may be advantageous to cycle the operation of pumps 105 and 111 so that the mixture “pauses” within the tube for a brief period (e.g., 5 seconds). If the flow rate through the coagulation tube is too slow, the pre-curd mixture will harden (i.e., greatly increase in viscosity) and bind the tube. If the flow rate is too fast, the pre-curd mixture will have insufficient time to coagulate, and the output (i.e., curd fluid) will have a consistency unsuitable for subsequent processing. In presently preferred circumstances, the flow rate is high enough to avoid hardening, but not so high as to induce any turbulence in the flow.

In presently preferred implementations, the coagulation tube comprise two or more coagulation tubes, preferably at least 3 coagulation tubes, to increase the throughput of the pre-curd mixture through the system 100. Any combination of the coagulation tubes 113 may be inclined, flat, or coiled, depending on the desires of the skilled artisan. In typical circumstances, each coagulation tube of the plurality of coagulation tubes has the same length and diameter. In presently preferred circumstances, the coagulation tube 113 is about 16 feet long, with a diameter of about 1 inch. The coagulation tube 113 is preferably coiled and arranged in an ascending spial, without a similar straight, inclined path for the pre-curd mixture as in coagulation tube 13. The present inventors discovered that a pre-curd mixture may emerge from a longer, narrower coagulation tube with sufficient coagulation and viscosity for further processing in under 15 minutes. In some embodiments, the pre-curd mixture emerges with sufficient coagulation and viscosity within 5 to 7 minutes. The coagulation tube 113, despite its length, preferably lacks any joints or kinks which may disrupt the desired flow rate of the coagulating mixture.

Additional cultures or food grade acids may optionally be introduced to the coagulation tube to further lower the pH. These additives may be introduced at the entrance of the tube, or midstream.

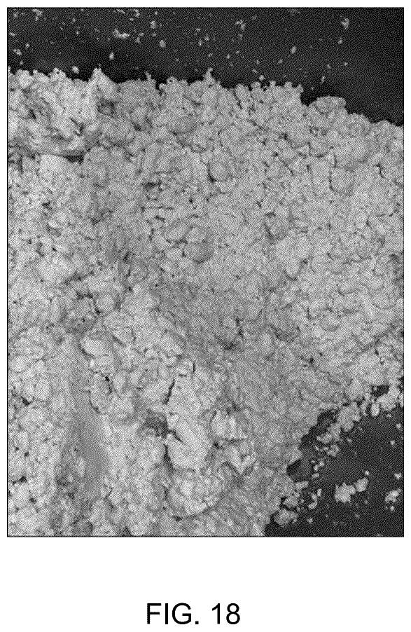

The curd fluid emerges from the distal opening of the coagulation tube(s) 113 to a cooking vat 140, where the curd is heated in water to finish coagulation. In typical circumstances, the curd is stirred in water heated to about 115° F. (about 46° C.), as measured before the addition of the curd fluid. The cooking vat 140 may be steam jacketed and equipped with mechanical agitators to indirectly heat the water. The curd fluid is typically heated for up to 15 minutes. Heating in excess of 15 minutes may result in loss of volume in the curd, affecting both the taste of the resulting cheese and the system 100 throughput. Exemplary cooked curd is depicted in FIG. 18.

The sufficiently cooked and heated curd is transferred through an outlet of the cooking vat 140, via elevator, auger, or other mechanism 141, to a belt drier 118 (i.e., dewatering belt). The belt drier 118 may be a perforated conveyor belt, where the whey and other remaining fluid can flow off during the transport along the belt, such that only relatively large pieces of cheese curd remain. Salt (e.g., NaCl) may be applied to the dried or drying curd at salt mill 119. The salted curd is delivered to a grinder 122, for example via elevator 123, where it is crumbled into smaller pieces. Carbon dioxide may be added to the grinder 122 at the CO2 application point 120. A pump 121 may be used to push desired volumes of crumbled cheese to one or more packaging stations 126.

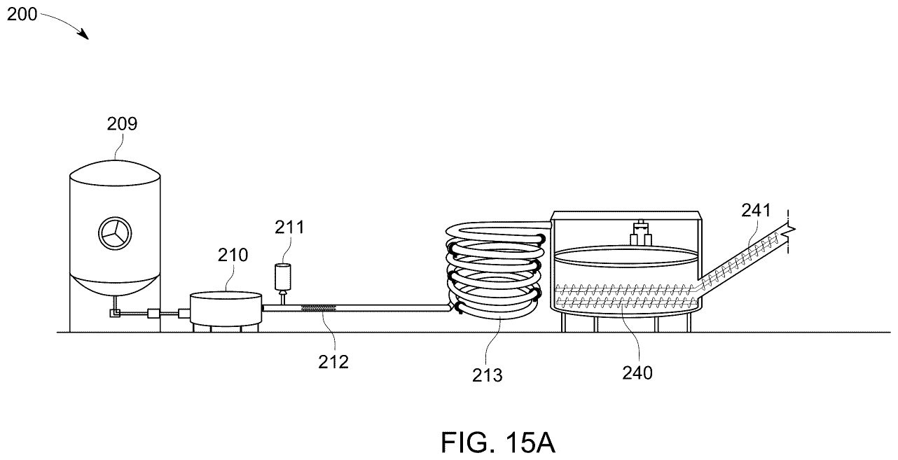

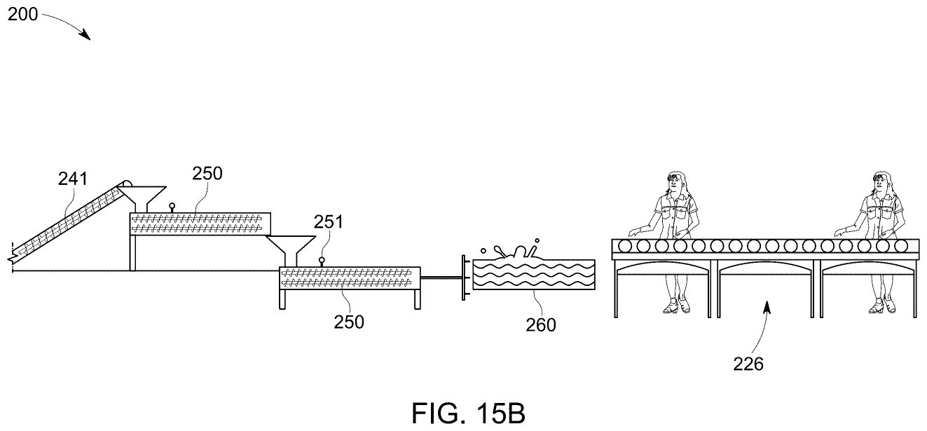

FIGS. 15A and 15B illustrate a system 200 well-suited for producing Oaxaca cheese in accordance with another embodiment of the present disclosure. The system 200 may also be used for producing other fresh cheeses if desired. The system may incorporate components from systems 1 and 100 described above, with like components identified with like reference characters. The system 200 includes a milk tank 209 housing a pre-cheese milk mixture. The system 200 as depicted omits any other pre-treatment (i.e., pasteurization, solids addition, culturing, etc.) equipment or steps, though the skilled person will recognize that any desired pre-processing may be performed on the precursor milk before storage in the tank 209.

One exemplary pre-cheese milk mixture for Oaxaca cheese contains about 70% milk, 29% whole powdered milk, culture, and calcium chloride. Thanks to the high throughput and yield of system 200, the precursor milk need not contain any common preservatives or higher levels of acid that cause cheese flavor to suffer. Even without the omitted ingredients, the cheese remains fresh and safe to consume.

In some embodiments, the pre-cheese mixture is non homogenized. In other embodiments, a culture and vegetable fat are added to the cream in the cream tanks/cream tubing. The resulting cream is added back to milk and aged for 12-18 hour at 90° F. to 110° F. (about 32° C.-43° C.). The cream and milk mixture is subsequently cultivated and homogenized. In these embodiments, the flavor of the resulting cheese is akin to typical Oaxaca made by hand under ambient conditions in Mexico.

As in systems 1 and 100, the milk mixture is further mixed with coagulant and pushed through one or more coagulation tubes 213 where curd is formed. In presently preferred circumstances, the coagulation tube 213 is about 30 feet long, with a diameter of about 1 inch. The coagulation tube 213 is preferably coiled and arranged in an ascending spiral, without a similar straight, inclined path for the pre-curd mixture as in coagulation tube 13. The present inventors discovered that a pre-curd mixture may emerge from a longer, narrower coagulation tube with sufficient coagulation and viscosity for further processing in under 15 minutes. In some embodiments, the pre-curd mixture emerges with sufficient coagulation and viscosity within 5 to 7 minutes. The coagulation tube, despite its length, preferably lacks any joints or kinks which may disrupt the desired flow rate of the coagulating mixture.

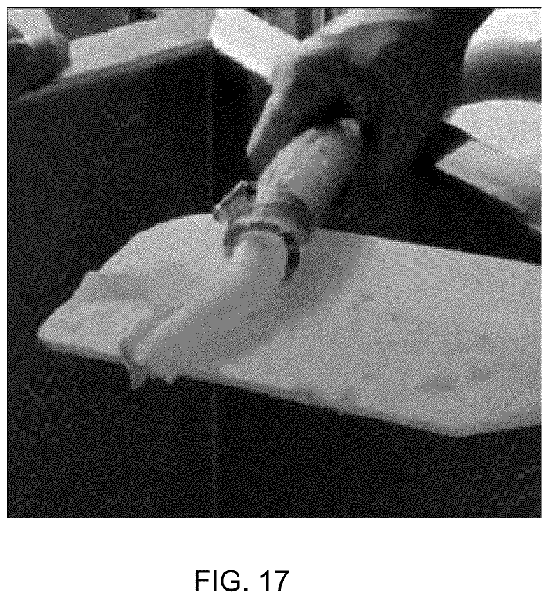

The curd emerges from the distal opening of the coagulation tube(s) 213 to a cooking vat 240, where the curd is heated in water to finish coagulation. The curd emerging from the tube 213 preferably has a toothpaste-like, self-supporting gel consistency, in that retains the shape of the coagulation tube upon exit (as shown in FIG. 17). The consistency may, however, be tailored by the skilled person by adjusting, e.g., the solids content and pH of the precursor milk, the temperature and dimensions of the coagulation tube, the flow rate of the milk/rennet mix through the coagulation tube.

In typical circumstances, the curd is stirred in water heated to about 115° F. (˜46° C.)., as measured before the addition of the curd. The curd is typically heated for up to 15 minutes.

The sufficiently cooked and heated curd is transferred through an outlet of the cooking vat 240, via elevator 241, auger, or other mechanism, to a stretching machine 250. The curd may be pumped through a filling head (not depicted) at the distal end of the elevator, similar to filling head 28. The lightly molded curd delivered through the filling head may has sufficient surface area, coherence, and elasticity for stretching. At this stage, melting salt (i.e., Mexican salt) may be added to assist the subsequent opening of the cheese. If used, melting salt may added to a concentration of about 8.4% by weight, based on the total weight of the cooked curd. A suitable melting salt is available as Oaxaca-Sol Analog Cheese Mix.

The curd may be mechanically worked in the stretcher to open the cheese immediately while still fresh from the cooking vat 240. When the curd particles are heated and stretched, the curd is heated to a temperature of between about 50° C. and 90° C. either by immersing the curd in hot water or hot whey, by heating and stretching in a dry environment, or by heating and stretching in the presence of steam. In any method, the curd is heated and stretched into a homogenous mass of gum-like consistency. The stretch may occur using rotary paddles or counter-rotating augers. Preferably the curd is heated to a curd temperature of between about 50° C. to 75° C. using equipment common in the art. In presently preferred circumstances, the heating occurs indirectly in a jacketed tube 251, similar to coagulation tube 213. Suitable stretching equipment is available from GEA Group AG (Düsseldorf, Germany). The curd may be heated both during and after stretching, as desired.

The hot stretched curd is extruded in ribbon or like form from the stretching machine 250 and cooled by immersing in a salt brine bath 260 for a period of time to completely cool the cheese. The salt content of the salt brine bath is typically 1%-3%, based on the total volume of the brine. Typically, the curd remains in the brine for about 5-15 minute. Once cooled to a temperature of 2° C. to 20° C., the cheese may be routed to a packaging system 226. The cooling of the cheese structures at this stage provides enhanced texture to the cheese product, but the temperature should be held above freezing.

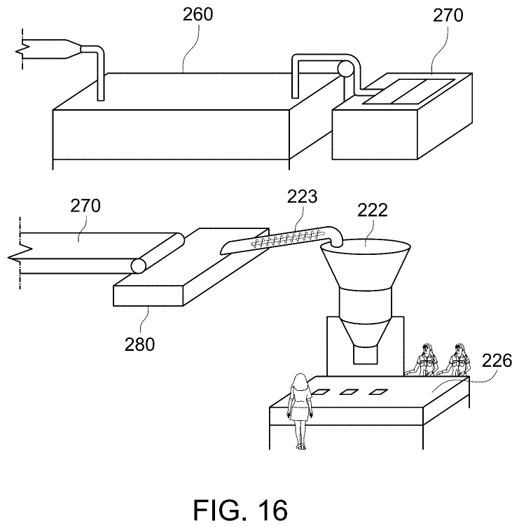

FIG. 16 depicts an alternative aspect of the system 200, with further processing once the cheese emergers from the cold bath 260. The bath 260 in this embodiment may be a brine bath as above or simply cold water. Rather than immediately packaged, the cold cheese ribbons are delivered to a shredder 270 to further mechanically work and break up the cheese. Cellulose is applied to the shredded cheese at cellulose applicator 280. The application of about 0.01%-0.02% by weight of cellulose aids in the reduction or prevention of clumping of the shredded cheese.

Similar to system 100, the cold, shredded cheese is delivered from the cellulose applicator to a grinder 222, for example via elevator 223, where it is crumbled into smaller pieces and subsequently packaged at one or more packaging stations 226. For Oaxaca cheese, application of carbon dioxide is unwelcome at this stage.

The described systems and methods for making cheese may yield approximately 50-80% more cheese in any given time compared to traditional methods of making soft cheeses, which typically yield under 35% cheese based on the starting volume of milk. The systems may be run continuously, with greater control over temperature, pH, and cheese consistency. In particular, but not exclusively, for Oaxaca cheese, the systems and methods of the present disclosure provide a greater degree of recipe and process standardization, improving the taste and consistency of the cheese product. Furthermore, greater automation and control over the pH of the curd and cheese reduces contamination and outbreaks of listeria.

The systems of the present disclosure are also highly adaptable, in that they may be used to prepare a variety of cheeses from the same roster of equipment and components, requiring fewer humans to manipulate the curd. The system and methods only need a small footprint, which allows current cheese makers adaptability within current configurations. Also, the small footprint allows farmers who do not currently make cheese, but have access to idle milk to make cheese without a massive investment and/or need for substantial space.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for”or “step for”are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A system for forming cheese, the system comprising:
a milk tank for holding milk;
a rennet pump for adding rennet to the milk to form a milk and rennet mixture;
a tube coagulator, wherein the milk and rennet mixture coagulates while traveling through the tube coagulator and curd exits the tube coagulator; and
a grinder for grinding the curd.

2. The system of claim 1, further comprising a rennet stirring tube for homogenizing the milk and rennet mixture.

3. The system of claim 1, further comprising milk silos wherein powder is added to the milk before it is sent to the milk tank.

4. The system of claim 1, further comprising a cream tank wherein the milk with powder added is sent to the cream tank for heating before being sent to the milk tank.

5. The system of claim 1, further comprising a dewatering belt for dewatering the curd after it exits the tube coagulator and before it is sent to the grinder.

6. The system of claim 1, further comprising a salt mill for adding salt to the curd before it is sent to the grinder.

7. The system of claim 1, and further comprising a cooking vat for receiving the curd from the tube coagulator.

8. The system of claim 7, wherein the cooking vat is held at a temperature of about 115 degrees.

9. The system of claim 7 and further comprising a dewatering belt for dewatering the curd after it exits the cooking vat and before it is sent to the grinder.

10. The system of claim 1, wherein the grinder is coupled to a carbon dioxide source, and wherein the carbon dioxide source delivers carbon dioxide to the cheese as it is ground in the grinder.

11. The system of claim 7, and further comprising a stretching machine for opening the curd, the stretching working on the curd after it exits the cooking vat.

12. The system of claim 11, wherein the curd is heated during or after opening by the stretching machine.

13. The system of claim 11 and further comprising a cold brine bath for cooling the curd, wherein the cold brine bath receives open and heated curd from the stretching machine.

14. The system of claim 13, and further comprising a shredder downstream of the cold brine bath.

15. The system of claim 14 and further comprising a cellulose applicator.

16. The system of claim 1, wherein the tube coagulator has a length of about 10 to 30 feet, and a diameter of about 1-6 inches.

17. The system of claim 1, wherein coagulating milk and rennet mixture flows through the coagulating tube in laminar flow.

18. The system of claim 1, wherein tube coagulator comprises a plurality of tubes, and wherein the milk and rennet mixture flows through each of the plurality of tubes.

19. A method for forming soft cheese, the method comprising:
adding rennet to a milk precursor to form a milk and rennet mixture;
forcing the milk and rennet mixture through an elongated tube coagulator, wherein the milk and rennet mixture forms a curd as it travels through the tube coagulator;
cooking the curd;
at least partially drying the cooked curd;
salting the dried curd; and
grinding the salted curd in the presence of carbon dioxide.

20. A method for forming Oaxaca cheese, the method comprising:
adding rennet to a milk precursor to form a milk and rennet mixture;
forcing the milk and rennet mixture through an elongated tube coagulator, wherein the milk and rennet mixture forms a curd as it travels through the tube coagulator;
cooking the curd;
stretching and heating the cooked curd to form opened structures; and cooling the opened structures in a bath.

21. The method of claim 20, and further comprising shredding the cooled curd; applying cellulose to the curd; and grinding the curd.

22. The method of claim 20, wherein the milk precursor comprises one of food grade acid and culture.

23. The method of claim 20, and further comprising applying a melting salt to a surface of the cooked curd before stretching.

24. The method of claim 20, wherein the bath is a salt brine.

25. The method of claim 20 and further comprises forcing the cooked curd through a filling head having a rectangular cross-section.

26. The method of claim 20, wherein the milk and rennet mixture travels through the tube coagulator for 5 to 7 minutes.

27. The method of claim 20, wherein the milk precursor contains about 70% milk, 29% whole powdered milk, culture, and calcium chloride.
